(19) United States
(12) Patent Application Publication
(10) Pub. No.: US 2015/0191640 A1
(43) Pub. Date: Jul. 9, 2015

(54) HIGH-TEMPERATURE HIGH-PRESSURE RESERVOIR DRILLING FLUID

(71) Applicant: M-I, L.L.C., Houston, TX (US)

(72) Inventors: Lijein Lee, Sugar Land, TX (US); Balakrishnan Panamarathupalayam, Houston, TX (US); Pawilai Chinwangso, Humble, TX (US)

(21) Appl. No.: 14/591,455

(22) Filed: Jan. 7, 2015

Related U.S. Application Data
(60) Provisional application No. 61/924,626, filed on Jan. 7, 2014.
(60) Provisional application No. 62/016,440, filed on Jun. 24, 2014.

(51) Int. Cl. C09K 8/24; E21B 43/04; E21B 43/16; E21B 7/00

(52) U.S. Cl. CPC C09K 8/24; E21B 7/00; E21B 43/04; E21B 43/16

(57) ABSTRACT

A drilling fluid, comprising an aqueous continuous phase, a polymeric fluid loss control agent formed from at least an acrylamide monomer, and a sulfonated anionic monomer, and a gelling material comprising at least one of clay or a cross-linked polyvinylpyrrolidone.

This patent application claims priority, pursuant to 35 U.S.C. §119(e), to U.S. Provisional Application No. 61/924,626 filed Jan. 7, 2014, entitled “High-Temperature High-Pressure Reservoir Drilling Fluid” and U.S. Provisional Application No. 62/016,440 filed Jun. 24, 2014 and the disclosures of which are fully incorporated herein by reference.

### BACKGROUND

During the drilling of a wellbore, various fluids are used in the well for a variety of functions. The fluids may be circulated through a drill pipe and drill bit into the wellbore, and then may subsequently flow upward through the wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

However, another wellbore fluid used in the wellbore following the drilling operation is a completion fluid. Completion fluids broadly refer to any fluid pumped down a well after drilling operations have been completed, including fluids introduced during acidizing, perforating, fracturing, workover operations, etc. A drill-in fluid is a specific type of drilling fluid that is designed to drill and complete the reservoir section of a well in an open hole, i.e., the “producing” part of the formation. Such fluids are designed to balance the properties of the reservoir with drilling and completion processes. In particular, it is desirable to protect the formation from damage and fluid loss, and not impede future production. Most drill-in fluids contain several solid materials including viscosifiers, drill solids, and additives used as bridging agents to prevent lost circulation and as barite weighting material to control pressure formation.

During drilling, the filter cake builds up as an accumulation of varying sizes and types of particles. This filter cake may be removed during the initial state of production, either physically or chemically (i.e., via acids, oxidizers, and/or enzymes). The amount and type of drill solids affects the effectiveness of these clean up treatments. Also affecting the effectiveness of the clean up of the wellbore prior to production is the presence of polymeric additives, which may be resistant to degradation using conventional breakers.

The industry has proposed several ideas to deal with the invasion into the reservoir rock for open hole completion wells, most of them based on adding bridging agents to the fluid formulation. Such agents would block pores near the well bore and, consequently, prevent additional fluid to invade the rock.

Examples of formations in which problems often arise are highly permeable and/or poorly consolidated formation and thus a technique known as “under-reaming” may be employed. In conducting the under-reaming process, the wellbore is drilled to penetrate the hydrocarbon-bearing zone using conventional techniques. A casing generally is set in the wellbore to a point just above the hydrocarbon-bearing zone. The hydrocarbon-bearing zone then may be re-drilled to a wider diameter, for example, using an expandable under-reamer that increases the diameter of the wellbore. Under-reaming is performed using such special “clean” drilling fluids, drill-in fluids. The drill-in fluids used in under-reaming are aqueous, dense brines that are viscosified with a gelling and/or cross-linked polymer to aid in the removal of formation cuttings. However, the expense of such fluids limits their general use in the drilling process.

When the target subterranean formation has a high permeability, a considerable quantity of the drilling fluid may be lost into the formation. Once the drilling fluid is lost into the formation, it becomes difficult to remove. Removal of the aqueous based well fluids is desired to maximize the production of the hydrocarbon in the formation. It is well known in the art that calcium- and zinc-bromide brines can form highly stable, acid insoluble compounds when reacted with the formation rock itself or with substances contained within the formation. These reactions often may substantially reduce the permeability of the formation to any subsequent out-flow of the desired hydrocarbons. As should be well known in the art, it is widely and generally accepted that the most effective way to prevent such damage to the formation is to limit fluid loss into the formation. Thus, providing effective fluid loss control is highly desirable to prevent damaging the hydrocarbon-bearing formation. For example such damage may occur during completion, drilling, drill-in, displacement, hydraulic fracturing, workover, packer fluid emplacement or maintenance, well treating, or testing operations.

One class of viscosifiers commonly used in the petroleum industry comprises polymeric structures starting with molecular weights of hundreds of thousands to several million grams per mole. These large, chemically bonded structures are often cross-linked to further increase molecular weight and effective viscosity per gram of polymer added to the fluid. Such types of viscosifiers include polymeric additives resistant to biodegradation, extending the utility of the additives for the useful life of the mud. Specific examples of biodegradation resistant polymeric additives employed include biopolymers, such as xanthans (xanthan gum) and scleroglucan; various acrylic based polymers, such as polyacrylamides and other acrylamide based polymers; and cellulose derivatives, such as dialkylcarboxymethylcellulose, hydroxyethylcellulose and the sodium salt of carboxy-methylcellulose, guar gum, phosphomannans, scleroglucans, glucans, and dextrane.

Because of the high temperature, high shear (caused by the pumping and placement), high pressures, and low pH to which well fluids are exposed (“stress conditions”), the polymeric materials used to form fluid loss pills and to viscosify the well fluids tend to degrade rather quickly. In particular, for many of the cellulose and cellulose derivatives (such as HEC) used as viscosifiers and fluid loss control agents, degradation occurs at temperatures around 200° F. and higher. HEC, for example, is considered sufficiently stable to be used in an environment of no more than about 225° F. Likewise, because of the high temperature, high shear, high pressures, and low pH to which well fluids are exposed, xanthan gum is considered sufficiently stable to be used in an environment of no more than about 290 to 300° F. These large molecules are quite stable under the thermal conditions encountered in a subterranean reservoir. However, this thermal stability is believed to contribute to decreased well productivity. As a result, expensive and often corrosive breakers have been designed to destroy the molecular backbone of these polymeric structures. These breakers are oxidizers or enzymes and are partially effective with typical reservoir cleanup less than 80% complete and more much less than 50% complete.

The vast majority of oil and gas exploration is done with water based muds. The primary reason for this preference is price and environmental compatibility, the WBM being more environmentally acceptable than OBM (since the latter still give rise to the disposing of large quantities of oil contaminated drill cuttings, even if the oil is of low toxicity). However, the WBM are recognized as being technically inferior in a number of areas, such as thermal stability, lubricity, and shale inhibition. Oil and water base muds have contrasting attributes and disadvantages. Although drilling fluids utilizing an oil based mud inhibit wellbore swelling by minimizing dispersion fluid, the environmental toxicity of oil muds often overshadow the positive features. Oil base systems can be created with low toxicity, but these systems are pollutants to varying degrees. In addition, the cost parameters of an oil mud are often prohibitive when compared to a water based system. Furthermore, the rheological and thixotropic character of an oil mud is not as versatile for maximized hole cleaning as certain aqueous fluids.

High formation temperature, in particular, puts a strain on the equipment, as well as on the complex chemistry of drilling muds. Exposure to such temperatures can have a detrimental effect on viscosifying agents, resulting in a loss in viscosity of the fluid at high temperatures. A breakdown of the rheology, i.e. loss in viscosity, can result in the drilling fluid being unable to suspend the solids dispersed within it such as the weighting or bridging agent or even the drill cuttings which can lead to severe problems such as settlement, loss in fluid density and possibly a blowout of the well. Along with exorbitant costs and safety considerations, drilling in a high temperature high pressure (HTHP) environment poses the difficult challenge of protecting a reservoir that is all-too-often depleted. In areas where environmental restrictions and compatibility issues in gas fields prohibit the use of an oil-base drilling fluid, engineering a water-base fluid system that is free of potentially damaging solids, stable at very high temperatures, and able to withstand acid gases (CO₂, H₂S) or other contaminants is a very difficult proposition. Furthermore, since pressure and temperature heavily influences the rheological behavior, it is extremely difficult to calculate, predict and control pressure losses in real time to avoid total losses or kicks.

Some conventional materials, such as polysaccharide gums and sodium tetraborate crosslinking agents, are demonstrably unstable or simply rendered useless under high thermal loads. Maintaining the performance of muds and gels at high temperatures remains an ongoing challenge in the industry

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a drilling fluid, comprising an aqueous continuous phase, a polymeric fluid loss control agent formed from at least an acrylamide monomer, and a sulfonated anionic monomer, and a gelling material comprising at least one of clay or a cross-linked polyvinylpyrrolidone.

In another aspect, embodiments of the present disclosure relate to a method of drilling, comprising pumping a drilling fluid into a wellbore through an earthen formation, the drilling fluid comprising an aqueous continuous phase, a polymeric fluid loss control agent formed from at least an acrylamide monomer, and a sulfonated anionic monomer, and a gelling material comprising at least one of clay or a cross-linked polyvinylpyrrolidone.

Other aspects and advantages of the claimed subject matter will be apparent from the following description and the appended claims.

### DETAILED DESCRIPTION

Embodiments disclosed herein relate generally to high temperature high pressure drilling fluids. More specifically, embodiments disclosed herein relate to drilling fluids for downhole applications formed of a polymeric fluid loss control agent and a gelling material. It has been found that the combination of the polymeric fluid loss control additive and the gelling material may result in drilling fluids that exhibit improved stability in high pressure high temperature conditions, as well as improved viscosity and gel strength.

The drilling fluids of the present disclosure incorporate a polymeric fluid loss control agent that is formed from at least an acrylamide monomer and a sulfonated anionic monomer. In one or more embodiments, the polymeric fluid loss control agent may have an average molecular weight not higher than 500,000.

Drilling fluids of the present disclosure may contain other materials to comprise complete drilling fluids. Such other materials optionally may include, for example: additives to reduce or control low temperature rheology or to provide thinning, additives for enhancing viscosity, additives for high temperature high pressure control and emulsion stability. As with all drilling fluids, the exact formulations of the fluids of the present disclosure vary with the particular requirements of the subterranean formation.

One of the components of the drilling fluids of this disclosure is a polymer that enhances the functional capability of the entire drilling fluid system, more specifically the stability in high temperature high pressure conditions. The polymers that have shown utility in the drilling fluids of this disclosure are synthesized by using an acrylamide monomer and a sulfonated anionic monomer. Furthermore, the combination of such a polymer with a gelling agent results in improved thermal stability and rheological properties of the drilling fluid. The role of the thermally stable fluid is to maintain viscosity and fluid loss properties in the wellbore fluid, as it becomes exposed to increased temperatures encountered during drilling and production of oil and gas from subterranean formations.

The first characteristic of the drilling fluid which is controlled by the polymer additive of this disclosure is its viscosity. The viscosity of drilling fluids is very difficult to control because of the adverse conditions under which drilling fluids are used, as well as the excessively elevated temperatures to which they will be exposed. In this regard, during the drilling of certain deep wells, i.e., greater than 15,000 feet, it is common to be exposed to temperatures at which thermal decomposition of certain drilling fluid additives occurs. These temperatures can easily cause a severe change in the viscosity of the drilling fluid and thus adversely affect the flow characteristics of the drilling mud and adversely affect the overall drilling operation. Such viscosity modification at these temperatures is not acceptable in normal drilling fluids. Additionally, certain geographic regions have excessive geothermal activity resulting in extremely high temperatures. The effect on drilling fluids at these geothermally elevated temperatures may be similar to the effect of elevated temperatures in deep wells.

In any event, the viscosity of the drilling fluid is controlled within desired ranges, which are in many instances dependent on the geographic area of activity. The viscosity is a function of plastic viscosity and yield point. As a general rule, as the mud weight increases, the plastic viscosity increases, but the yield point increases by a much smaller magnitude.

A second characteristic is the gel strength of the drilling fluid. Gel strength is a characteristic of the drilling fluid which reflects the ability of the drilling fluid to maintain a suspension of additives and drill cuttings, especially when circulation is stopped. As can be appreciated, if circulation of the drilling fluid were terminated, and if all of the suspended cuttings and additives to the drilling fluid were then permitted to settle to the lowest point, the drill bit and drill string would be literally packed into a position that would result in severe levels of torque to rotate. Such torque might damage components of the drill string or in some instances cause the drill string to shear apart. Such a situation results in loss of the drill bit and sustained periods where positive footage is not being drilled.

If the drilling fluid gel strength is too low, it may be increased by increasing the amount of gelling agent incorporated in the fluid. Ideally, the drilling fluid gel strength should be just high enough to suspend barite and drill cuttings, or other solid particles, when circulation is stopped. However, too high of a gel strength can retard the separation of cuttings and of entrained gas at the surface, and also because they raise the pressure to reestablish circulation after changing bits. Furthermore, when pulling pipe, a high gel strength may reduce the pressure of the mud column beneath the bit because of a swabbing action. If the reduction in pressure exceeds the differential pressure between the mud and the formation fluids, the fluids will enter the hole, and possibly cause a blowout. Similarly, when running pipe into the hole, the downward motion of the pipe causes a pressure surge which may cause fracturing with consequent loss of circulation. Methods have been developed for calculation of the magnitude of these pressure surges.

Related to the gel strength control is the ability of the drilling fluid to tolerate divalent ions, including the compatibility of the various components (including polymeric fluid loss control agents and gelling agents) with divalent brines. For example, many products will not result in the same viscosity profile in divalent brines as compared to monovalent brines or fresh water. However, in HPHT wells, heavier, divalent brines may be needed to balance the pressures downhole. The drilling fluid additives of this disclosure display a high tolerance to divalent cations, especially calcium and magnesium.

Another function of the drilling fluid is its ability to seal permeable formations exposed by the bit with a low permeability filter cake. Fluid loss from the borehole is therefore reduced. In order for a filter cake to form, the drilling fluid contains particles of a size slightly smaller than that of the pore openings of the formation. These particles are trapped in the surface pores while finer particles are carried deeper into the formation. The particles which are deposited on the formation are known as the filter cake.

Polymeric Fluid Loss Control Agents

As mentioned above, drilling fluid formulations in accordance with the present disclosure include a copolymer formed from at least one acrylamide monomer and at least one sulfonated anionic monomer.

Acrylamides may be used as monomer building blocks in the polymerization reaction, to enhance the functional characteristics of the drilling fluid polymer additive. Thus, acrylamides play a role in creating an effective and high temperature stable fluid loss control agents, enhancing the fluid's high temperature endurance. In addition to unsubstituted acrylamide, in one or more embodiments, the acrylamide monomer may include N-substituted acrylamides, such as alkylacrylamides, N-methanol, N-isopropyl, diacetone-acrylamide, N-alkyl acrylamide (where alkyl is C₁ to C₁₄), N,N-dialkyl acrylamides (where alkyl is C₁ to C₁₄), N-cycloalkane acrylamides, combinations of the above and related compounds.

Further, as mentioned above, the at least one acrylamide monomer may be combined with a sulfonated anionic monomer. Incorporation of anionic monomers may repel negatively charged hydroxide ions which promote hydrolysis of the acrylamide moiety of the polymer. Sulfonated monomers, such as 2-acrylamide-2-methyl-propanesulfonic acid (AMPS), vinyl sulfonate, and styrene sulfonic acid and the like may provide tolerance to divalent cations such as calcium and magnesium encountered in drilling fluids. This results in an improved thermally stable fluid loss control agent for divalent cation systems such as brine based drilling fluids. Depending upon the reactivity ratio and the end use of the polymer, other sulfonated monomers may also be utilized for preparing an effective fluid loss control agent.

The high rate of polymerization at equimolar concentrations of acrylamide-AMPS monomers gives the highest molecular weight of the copolymers of this disclosure. An increase in AMPS monomer in acrylamide-sodium AMPS copolymer causes a decrease in molecular weight. Thus, by suitable choice of monomers and monomer ratios, the properties of the polymers of this disclosure can be tailored according to the end use of the polymer. The performance of the polymer of this disclosure depends on several factors ranging from molecular weight to ionic charge to microstructure of the polymers.

Further, it is also within the scope of the present disclosure that the copolymer may contain cross-linking therein (intramolecular chemical covalent bonds) depending on the desirable functional characteristics of the polymer. Cross-linking may be achieved, for example, by incorporation of cross-linking monomers such as methylenebisacrylamide, divinyl benzene, allylmethacrylate, tetra allyloxethane or other allylic bifunctional monomers.

A variety of polymerization systems may be employed, such as solution polymerization, gel polymerization and emulsion polymerization. Solution polymerization is carried out either in water or in an organic solvent. The resulting copolymer is isolated by distilling off the solvent or by precipitation. Precipitation is accomplished by adding a miscible organic solvent in which the copolymer is insoluble. Examples of suitable solvents are acetone, methanol, and other organic solvents.

The precursor monomers which are polymerized to form the drilling fluid additive of this disclosure are commercially available from a number of suppliers. AMPS, for example, is supplied by the Lubrizol Company. Acrylamide is available from other major chemical companies, for example, Dow Chemical Company.

Thus, in one of the embodiments, the copolymer is formed from a precursor acrylamide monomer of the following formula

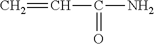

and AMPS monomer of the following formula

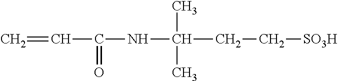

To effectively control the filtrate loss of aqueous base drilling fluids at high temperature, the polymers of this disclosure may be added to the drilling fluid in an amount ranging from 2 to 15 ppb, or 2 to 12 ppb or 4 to 10 ppb in other embodiments. The amount needed will vary, of course, depending upon the type of drilling fluid, contaminations and temperature conditions.

Further, it is also within the scope of the present disclosure that other monomers can be incorporated into the cross-linked polymer composition depending upon the end use of the polymer or the type of aqueous base drilling fluid. For example, lipophylic monomers, such as isobornyl methacrylate, 2-ethyl hexyl acrylate, N-alkyl and N,N-dialkyl acrylamide, styrene and the like can be incorporated to improve the performance of the polymer in high brine containing drilling fluids. Also, to make it more tolerant to other electrolytes, anionic monomers, such as maleic acid, tetrahydrophthalic acid, fumaric acid, acrylic acid and the like can be incorporated into the cross-linked polymers.

Gelling Materials

As mentioned above, gelling materials or agents may also be added to the drilling agent in order to alter or maintain the rheological properties of the fluid, particularly for suspension of solids within the fluid (including weight material, bridging agents, or cuttings).

Gelling agents suitable for use in the formulation of the drilling fluids of the claimed subject matter may be selected from clays and cross-linked polyvinylpyrrolidones. Cross-linked polyvinylpyrrolidones may include cross-linking via intramolecular covalent chemical bonds, which are not adversely effected by salt or pH conditions, as opposed to ionic bonds. In one embodiment, the cross-linked polyvinylpyrrolidones may be used in a range of 0.1 to 5 ppb. Clays, when used, may be used in a range of 1 to 10 ppb. Types of clays that may be used in the present embodiments include bentonite, attapulgite, and sepiolite. According to other embodiments of the present disclosure, a mixture of at least two gelling materials is used. In such embodiments, the mixture may include a clay material used in conjunction with a cross-linked polyvinylpyrrolidone or may include one of those two gelling agents used in combination with other conventional gelling agents. Such conventional gelling agents include, for example, high molecular weight polymers such as partially hydrolyzed polyacrylamide (PHPA), biopolymers, such as guar gum, starch, xanthan gum and the like. Further, it is also recognized that clay and cross-linked polyvinylpyrrolidone may also provide general viscosification and fluid loss control properties to the fluids of the present disclosure. Such functions do not change the function of their incorporation into the wellbore fluids of the present disclosure in combination with the copolymers described herein.

Base Fluids

The aqueous medium of the present disclosure may be water or brine. In those embodiments of the disclosure where the aqueous medium is a brine, the brine is water comprising an inorganic salt or organic salt. The salt may serve to provide desired density (to balance against the formation pressures), and may also reduce the effect of the water based fluid on hydratable clays and shales encountered during drilling. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a brine include any one or more of those present in natural seawater or any other organic or inorganic dissolved salts.

In one embodiment, the brine may be a divalent halide selected from the group of alkaline earth halides. The brine may also comprise an organic salt, such as sodium, potassium, or cesium formate. Inorganic divalent salts include calcium halides, such as calcium chloride or calcium bromide. Sodium bromide, potassium bromide, or cesium bromide may also be used. The salt may be chosen for compatibility reasons, i.e., where the reservoir drilling fluid used a particular brine phase and the completion/clean up fluid brine phase is chosen to have the same brine phase. In other embodiments, the divalent halide may be selected from transition metal ions including zinc, such as zinc bromide and/or zinc calcium bromide.

Additives

In one embodiment, the drilling fluid of the disclosure may further contain other additives and chemicals that are known to be commonly used in oilfield applications by those skilled in the art. A variety of additives can be included in the aqueous based drilling fluid of this disclosure with the purpose of formation of a thin, low permeability filter cake which seals pores and other openings in the formations which are penetrated by the bit. Such additives may include thinners, weighting material, wetting agents, surfactants, shale inhibitors, pH buffers, etc.

Examples of thinners include lignosulfonates, lignitic materials, modified lignosulfonates, polyphosphates and tannins. In other embodiments low molecular weight polyacrylates can also be added as thinners. Thinners are added to a drilling fluid in order to reduce flow resistance and gel development. Other functions performed by thinners include the reduction of filtration and cake thickness, to counteract the effects of salts, to minimize the effects of water on the formations drilled, to emulsify oil in water, and to stabilize mud properties at elevated temperatures.

The high temperature high pressure drilling fluid of the present disclosure additionally includes a weighting material, sometimes referred to as a weighting agent. The type and quantity of weighting material used may depend upon the desired density of the final drilling fluid composition. Weight materials include, but are not limited to: barite, iron oxide, calcium carbonate, magnesium carbonate, and combinations of such materials and derivatives of such materials. The weight material may be added in a quantity to result in a drilling fluid density of up to 24 pounds per gallon. In an embodiment, the particulate weighting agent may be composed of an acid soluble material such as calcium carbonate, magnesium carbonate, Mn₃O₄, etc.

The solid weighting agents may be of any particle size (and particle size distribution), but some embodiments may include weighting agents having a smaller particle size range than API grade weighing agents, which may generally be referred to as micronized weighting agents. Such weighting agents may generally be in the micron (or smaller) range, including submicron particles in the nanosized range. One of ordinary skill in the art would recognize that, depending on the sizing technique, the weighting agent may have a particle size distribution other than a monomodal distribution. That is, the weighting agent may have a particle size distribution that, in various embodiments, may be monomodal, which may or may not be Gaussian, bimodal, or polymodal.

Further, it is also envisioned that the fluid may be buffered to a desirable pH using, for example, magnesium oxide. The compound serves as to buffer the pH of the drilling fluid and thus maintain the alkaline conditions under which the process of hydrolysis or degradation of the polymers is retarded.

The fluids may be formulated or mixed according to various procedures; however, in particular embodiments, the polymeric fluid loss control agent of the present disclosure may be yielded in fresh water prior to be added to a brine (or vice versa). Thus, after the polymer yields in fresh water, a brine (such as a divalent halide) may be combined with the yielded polymer. The gelling agent may be added to the yielded polymer either before, after, or simultaneous with the brine.

Upon mixing, the fluids of the present embodiments may be used in drilling operations. Drilling techniques are known to persons skilled in the art and involve pumping a drilling fluid into a wellbore through an earthen formation. The fluids of the present embodiments have particular application for use in high temperature environments. The drilling fluid formulations disclosed herein may possess high thermal stability, having particular application for use in environments of up to 450° F. In yet another embodiment, the fluids of the present disclosure are thermally stable for at least 16 hours.

One embodiment of the present disclosure involves a method of drilling a wellbore. In one such illustrative embodiment, the method involves pumping a drilling fluid into a wellbore during the drilling through a reservoir section of the wellbore, and then allowing filtration of the drilling fluid into the earthen formation to form a filter cake on the wellbore walls. The filter cake is partially removed afterwards, thus allowing initiation of the production of hydrocarbons from reservoir. The formation of such a filter cake is desired for drilling, particularly in unconsolidated formations with wellbore stability problems and high permeabilities. Further, in particular embodiments, the fluids of the present disclosure may be used to drill the reservoir section of the well, and the open hole well may be subsequently completed (such as with placement of a screen, gravel packing, etc.) with the filter cake remaining in place. After the completion equipment is installed, removal of the filter cake may be achieved through use of a breaker fluid (or internal breaking agent).

According to various embodiments, the drilling fluid formulations of the present disclosure may be easily transportable and maintain their properties during transportation. The effectiveness of a drilling fluid and in particular the additives found in the drilling fluid is evaluated by measurement of certain characteristics of the drilling system. The viscosity, gel strength, filtrate loss, contamination control and tolerance to divalent ion characteristics of drilling fluids and drilling systems are all directly attributable to the components of the drilling fluid or drilling mud.

Breaker Fluids

In embodiments described herein, by filtration of the drilling fluid into the earthen formation, a filter cake is formed on the wellbore walls. After completion of the drilling or completion process, the filter cake may be broken by application of a breaker fluid. The breaker fluid may be circulated in the wellbore during or after the performance of the at least one completion operation. In other embodiments, the breaker fluid may be circulated either before, during, or after a completion operation has commenced to destroy the integrity of and clean up residual drilling fluids remaining inside casing or liners. The breaker fluid contributes to the degradation and removal of the filter cake deposited on the sidewalls of the wellbore to minimize negatively impacting production. Upon cleanup of the well, the well may then be converted to production.

In one or more embodiments, before, during, or after a completion operation has started or upon conclusion of all completion operations, the circulation of an acid wash such as hydrochloric acid, sulfuric acid, citric acid, formic acid, acetic acid, other organic acids, or mixtures thereof may be used to at least partially dissolve some of the filter cake remaining on the wellbore walls. Other embodiments may use breaker fluids that contain hydrolysable esters of organic acids and/or various oxidizers in combination with or in lieu of an acid wash.

Examples of suitable organic acids that may be used as the breaking agent may include salicylic acid, glycolic acid, malic acid, maleic acid, fumaric acid, and homo- or copolymers of lactic acid and glycolic acid as well as compounds containing hydroxy, phenoxy, carboxylic, hydroxycarboxylic or phenoxycarboxylic moieties. In addition to organic acids, hydrolysable esters which may hydrolyze to release an organic (or inorganic) acid may also be used, including, for example, hydrolyzable esters of a C₁ to C₆ carboxylic acid and/or a C₂ to C₃₀ mono- or poly-alcohol, including alkyl orthoesters. In addition to these hydrolysable carboxylic esters, hydrolysable phosphonic or sulfonic esters could be utilized, such as, for example, R¹H₂PO₃, R¹R²HPO₃, R¹R²R³PO₃, R¹HSO₃, R¹R²SO₃, R¹H₂PO₄, R¹R²HPO₄, R¹R²R³PO₄, R¹HSO₄, or R¹R²SO₄, where R¹, R², and R³ are C₂ to C₃₀ alkyl-, aryl-, arylalkyl-, or alkylaryl- groups. One example of a suitable hydrolysable ester of carboxylic acid is available from M-I, L.L.C. (Houston, Tex.) under the name D-STRUCTOR.

In some instances, it may also be desirable to include an oxidant in the breaker fluid, to further aid in breaking or degradation of polymeric additives present in a filter cake. Examples of such oxidants may include any one of those oxidative breakers known in the art to react with polymers such as polysaccharides to reduce the viscosity of polysaccharide-thickened compositions or disrupt filter cakes. Such compounds may include peroxides (including peroxide adducts), other compounds including a peroxy bond such as persulphates, perborates, percarbonates, perphosphates, and persilicates, and other oxidizers such as hypochlorites, which may optionally be encapsulated as taught by U.S. Pat. No. 6,861,394, which is assigned to the present assignee. Further, use of an oxidant in a breaker fluid, in addition to affecting polymeric additives, may also cause fragmentation of swollen clays, such as those that cause bit balling.

It should be appreciated that the amount of delay between the time when a breaker fluid according to the present disclosure is introduced to a well and the time when the fluids have had the desired effect of breaking/degrading/dispersing the filter cake may depend on several variables. One of skill in the art should appreciate that factors such as the downhole temperature, concentration of the components in the breaker fluid, pH, amount of available water, filter cake composition, etc. may all have an impact. For example downhole temperatures can vary considerably from 100° F. to over 400° F. depending upon the formation geology and downhole environment. However, one of skill in the art via trial and error testing in the lab should easily be able to determine and thus correlate downhole temperature and the time of efficacy of for a given formulation of the breaker fluids disclosed herein. With such information one can predetermine the time period necessary to shut-in a well given a specific downhole temperature and a specific formulation of the breaker fluid.

However it should also be appreciated that the breaker fluid formulation itself and thus the fluid's chemical properties may be varied so as to allow for a desirable and controllable amount of delay prior to the breaking of invert emulsion filter cake for a particular application. In one embodiment, the amount of delay for an invert emulsion filter cake to be broken with a water-based displacement fluid according to the present disclosure may be greater than 1 hour. In various other embodiments, the amount of delay for an invert emulsion filter cake to be broken with a water-based displacement fluid according to the present disclosure may be greater than 3 hours, 5 hours, or 10 hours. Thus the formulation of the fluid can be varied to achieve a predetermined break time and downhole temperature.

The superior thermal stability and performance of the formulations of this disclosure in controlling the filtrate loss from the drilling fluid were determined by conducting the following tests.

Rheology Test

Viscosity is a measurement describing the flow properties of drilling fluids and their behavior while under influence of shear stress. Using a Fann 35 Viscometer, Fann 70 Viscometer, Grace Viscometer, the rheological parameters namely plastic viscosity (PV) and yield point (YP) are determined. One of skill in the art will appreciate that the viscosity measurements will be dependent upon the temperature of the gel composition, the type of spindle, and the number of revolutions per minute. Generally, increase in the plastic viscosity and yield point values are proportional to increase of the drilling fluid density, but the yield point increases by a smaller magnitude.

Plastic Viscosity Test

Plastic viscosity (PV) is one variable used in the calculation of viscosity characteristics of a drilling fluid, measured in centipoise (cP) units. PV is the slope of the shear stress-shear rate plot above the yield point and is derived from the 600 rpm reading minus the 300 rpm reading. A low PV indicates that the mud is capable of drilling rapidly because of the low viscosity of mud exiting at the bit. High PV is caused by a viscous base fluid and by excess colloidal solids. To lower PV, a reduction in solids content can be achieved by dilution.

Yield Point Test

Yield point (YP) is another variable used in the calculation of viscosity characteristics of drilling fluids, measured in pounds per 100 feet square (lb/100 ft²). The physical meaning of the Yield Point (YP) is the resistance to initial flow. YP is used to evaluate the ability of mud to lift cuttings out of the annulus. The Bingham plastic fluid plots as a straight line on a shear-rate (x-axis) versus shear stress (y-axis) plot, in which YP is the zero-shear-rate intercept (PV is the slope of the line). YP is calculated from 300-rpm and 600-rpm viscometer dial readings by subtracting PV from the 300-rpm dial reading and it is reported as lbf/100 ft². A higher YP implies that drilling fluid has ability to carry cuttings better than a fluid of similar density but lower YP.

pH Test

The pH test is performed using pH paper to determine the acidity of the drilling fluid.

High Temperature High Pressure Fluid Loss Test

“HTHP” is the term used for high temperature high pressure fluid loss, measured in milliliters (mL) according to API bulletin RP 13 B-2, 1990. This test is conducted for testing fluid loss behavior of mud. Mud is pressed through filter paper located in the HTHP filter press at 300° F. with differential pressure at 500 psi for 30 minutes. Thickness of filter cake stuck in filter paper should be less than 2 ml.

Gel Strength Test

The gel strength (thixotropy) is the shear stress measured at low shear rate after a mud has set quiescently for a period of time (10 seconds and 10 minutes in the standard API procedure, although measurements after 30 minutes or 16 hours may also be made).

The preparation and the superior properties of the drilling fluids of the present disclosure in a thermally elevated and contaminated environment are further described in the following examples.

The following examples are presented to illustrate the preparation and properties of the fluids and should not be construed to limit the scope of the disclosure, unless otherwise expressly indicated in the appended claims. All percentages, concentrations, ratios, parts, etc. are by weight unless otherwise noted or apparent from the context of their use.

The drilling fluids of this disclosure, which include the fluid loss control agent and the gelling material comprising a clay and a cross-linked polymer, effectively control the viscosity, gel strength and fluid loss of an aqueous drilling fluid when exposed to high temperatures.

### EXAMPLES

The following examples are provided to further illustrate the application and the use of the methods and compositions of the present disclosure. The present examples tested different drilling fluid formulations to assess their potential to be stable at high temperatures while providing increased viscosity and gel strength.

### Example 1

The first option of drilling fluid formulations used as control for comparison with other formulations is a combination of xanthan gum, FLA and SAFE-CARB, as shown in Table 1. Xanthan gum is a high-purity, high-viscosity xanthan gum which delivers exceptional rheological properties to drill-in fluids (available from Drilling Specialties), and sized calcium carbonate used as a bridging and weighting agent. POLYTEX® AHT is a fluid loss control additive (available from TBC-Brinadd), and the vinyl amide/vinyl sulphonate copolymer based fluid loss additive is available from MI SWACO.

To fully assess the properties of the two formulations, the rheology of the resulting drilling fluids was measured using a Fann 35 Viscometer at the rpm indicated. Each of the drilling fluids was hot rolled overnight at 375° F. In addition, gel strength, marked as “gels”, was measured at a 10 second and then at a 10 minute interval, with a Fann 35 Viscometer set at 3 rpm. The rheological parameters are as shown in Table 1 below.

TABLE 1
Drilling fluid formulations and their rheological properties

| Formulation | Sample 1 | | Sample 2 | |
|---|---|---|---|---|
| 14.2 ppg CaBr₂, g | 499 | | 499 | |
| Freshwater, g | 36 | | 36 | |
| xanthan gum, g | 1.75 | | 1 | |
| Polytex | 8 | | — | |
| vinyl amide/vinyl | — | | 8 | |
| sulphonate | | | | |
| copolymer based | | | | |
| fluid loss additive | | | | |
| MgO, g | 5 | | 5 | |
| sized calcium | 16 | | 16 | |
| carbonate 40, g | | | | |
| sized calcium | 12 | | 12 | |
| carbonate 10, g | | | | |
| sized calcium | 12 | | 12 | |
| carbonate 2, g | | | | |
| | Initial | AHR at 350° F. | Initial | AHR at 350° F. |
| Rheology | 75 F. | 75 F. | 75 F. | 75 F. |
| 600 rpm | 56 | 17 | 149 | 62 |
| 300 rpm | 32 | 9 | 83 | 32 |
| 200 rpm | 23 | 6 | 59 | 23 |
| 100 rpm | 13 | 4 | 33 | 13 |
| 6 rpm | 2 | 1 | 4 | 2 |
| 3 rpm | 2 | 1 | 3 | 2 |
| PV, cP | 24 | 8 | 66 | 30 |
| YP, lbs/100 ft² | 8 | 1 | 17 | 2 |
| 10″ Gels | 2 | 1 | 4 | 2 |
| 10′ Gels | 2 | 2 | 4 | 3 |
| pH | 7.92 | 7.49 | 7.87 | 7.78 |

### Example 2

Three sample formulations were mixed, which include xanthan gum, DUROGEL (a sepiolite clay available from MI SWACO), DRISCAL® D (an acrylamide-AMPS copolymer available from Drilling Specialties) and sized calcium carbonate. The samples were formulated as shown in Table 2 below.

The drilling fluids were hot rolled overnight at 375° F. The rheology of the formulations was tested using a Fann 35 Viscometer (Fann Instrument Company) at 375° F., as shown in Table 2.

TABLE 2
Drilling fluid formulations and their rheological properties

| Formulation | Sample 3 | | Sample 4 | | Sample 5 | |
|---|---|---|---|---|---|---|
| 14.2 ppg CaBr₂, g | 497 | | 492 | | 106 | |
| Freshwater, g | 36 | | 38.5 | | 38.5 | |
| xanthan gum, g | 2 | | — | | 1 | |
| MgO, g | 5 | | 5 | | 5 | |
| DUROGEL, g | — | | 5 | | 5 | |
| DRISCAL D, g | 8 | | 8 | | 8 | |
| 14.2 ppg CaBr₂, g | | | | | 385 | |
| Sized calcium | 40 | | 40 | | 40 | |
| carbonate 2, g | | | | | | |
| | | AHR | | AHR at | | AHR |
| | Initial | at 375° F. | Initial | 375° F. | Initial | at 375° F. |
| Rheology | 75 F. | 75 F. | 75 F. | 75 F. | 75 F. | 75 F. |
| 600 rpm | 76 | 112 | 34 | 162 | 62 | 260 |
| 300 rpm | 48 | 56 | 14 | 89 | 36 | 139 |
| 200 rpm | 37 | 39 | 10 | 66 | 26 | 94 |
| 100 rpm | 22 | 22 | 5 | 40 | 17 | 54 |
| 6 rpm | 4 | 3 | 1 | 6 | 4 | 8 |
| 3 rpm | 2 | 2 | 1 | 4 | 3 | 7 |
| PV, cP | 28 | 56 | 20 | 73 | 26 | 121 |
| YP, lbs/100 ft² | 20 | 0 | −6 | 16 | 10 | 18 |
| 10″ Gels | 2 | 3 | 1 | 4 | 3 | 6 |
| 10′ Gels | 4 | 3 | 3 | 6 | 7 | 7 |
| pH | 7.82 | 7.43 | 7.82 | 7.59 | 7.66 | 7.36 |

The data comparison with the control samples revealed that the formulations containing xathan gum, DUROGEL and DRISCAL® D exhibited higher viscosity compared to the control. Of particular significance is the comparatively improved YP of the formulations containing DUROGEL and DRISCAL® D. However, an increase in the PV is observed compared to the control samples. Additionally, the comparative gel strength data shows a slight increase in the gel strength of the formulations containing DUROGEL and DRISCAL® D.

HTHP fluid loss was measured according to procedures outlined in API spec 13B. The fluid loss for the drilling fluid formulations is as shown in Table 3 below.

TABLE 3
Fluid loss at 350° F. and 375° F. on a 5 micron disk

| | Fluid loss (mL) | | |
|---|---|---|---|
| Time | Sample 3 | Sample 4 | Sample 5 |
| (min) | HTHP 350 F. | HTHP 350 F. | HTHP 375 F. |
| 1 | 3.8 | 4.2 | 2.6 |
| 15 | 8.8 | 6.2 | 6.2 |
| 30 | 14.4 | 7.4 | 8 |
| 60 | 19 | 9.4 | 10.6 |
| 90 | 21.4 | 10.2 | 11.8 |
| 120 | 23.6 | 11.4 | 13.6 |
| 180 | 26.8 | 13 | 16.8 |
| 240 | 29.4 | 14.8 | 18.4 |
| 300 | 31.8 | 16 | 20 |
| 360 | 33.8 | 17.4 | 24 |

### Example 3

Three sample formulations were mixed, which include the following additives: DUROGEL, FLO-VIS PLUS (xanthan gum available from M-I-SWACO), DRISCAL® D, sized calcium carbonate and D-STROYER (an internal breaker available from MI SWACO). The samples were formulated as shown in Table 4 below.

The drilling fluids were hot rolled at 375° F. for 16 hours. The rheology of the resulting wellbore fluid was measured using a Fann 35 Viscometer at 375° F.

As shown in Table 4, the formulations containing DUROGEL, FLO-VIS Plus, DRISCAL® D and D-STROYER have improved viscosity at 375° F., compared to the control formulations. However, the addition of D-STROYER has a result of decreasing the values of the viscosity. Of particular significance is the comparatively improved YP. However, an increase in the PV is observed compared to the control samples. In addition, the comparative gel strength data establishes improved gel strength of the formulations containing DUROGEL, FLO-VIS Plus, DRISCAL® D and D-STROYER, with higher gel strength for the formulations lacking the D-STROYER additive.

TABLE 4
Drilling fluid formulations and their rheological properties

| Formulation | Sample 6 | | Sample 7 | | Sample 8 | |
|---|---|---|---|---|---|---|
| 14.2 ppg | 105 | | 105 | | 105 | |
| CaBr₂, g | | | | | | |
| Freshwater, g | 75 | | 75 | | 75 | |
| DUROGEL, g | 5 | | 5 | | 5 | |
| FLO-VIS Plus, | | | 0.25 | | 0.25 | |
| g | | | | | | |
| MgO, g | 5 | | 5 | | 5 | |
| DRISCAL D, g | 8 | | 8 | | 8 | |
| 14.2 ppg | 285 | | 285 | | 285 | |
| CaBr₂, g | | | | | | |
| calcium | 105 | | 105 | | 105 | |
| carbonate 2, g | | | | | | |
| D-STROYER, | | | | | 4 | |
| g | | | | | | |
| | | AHR at | | AHR at | | AHR at |
| | Initial | 375° F. | Initial | 375° F. | Initial | 375° F. |
| Rheology | 120 F. | 120 F. | 120 F. | 120 F. | 120 F. | 120 F. |
| 600 rpm | 126 | 152 | 142 | 150 | 145 | 74 |
| 300 rpm | 81 | 104 | 95 | 102 | 97 | 53 |
| 200 rpm | 63 | 86 | 75 | 86 | 77 | 44 |
| 100 rpm | 40 | 62 | 48 | 63 | 51 | 34 |
| 6 rpm | 8 | 22 | 8 | 23 | 11 | 16 |
| 3 rpm | 7 | 19 | 7 | 20 | 8 | 14 |
| PV, cP | 45 | 48 | 47 | 48 | 48 | 21 |
| YP, lbs/100 ft² | 36 | 56 | 48 | 54 | 49 | 32 |
| 10″ Gels | 4 | 12 | 5 | 13 | 6 | 9 |
| 10′ Gels | 9 | 14 | 10 | 17 | 11 | 13 |
| pH | 8.02 | 7.42 | 7.98 | 7.26 | 7.96 | 7.28 |

### Example 4

Compositions of two sample formulations are set forth in Table 5 below. The additives used for the formulations were DUROGEL, DRISCAL® D and sized calcium carbonate. Before testing, the samples were hot rolled at 375° F. for 16 hours. The results of the rheological tests are provided below in Table 5. Table 5 shows that the addition of DUROGEL and DRISCAL® D in the absence of a xanthan additive results in an increase of the YP and PV values of the drilling fluid, but maintained similar or lower PV relative to the control.

TABLE 5
Drilling fluid formulations and their rheological properties

| Formulation | Sample 9 | Sample 10 |
|---|---|---|
| 14.2 ppg CaBr₂, g | 105 | 105 |
| Freshwater, g | 60 | 75 |
| DUROGEL, g | 5 | 3.5 |
| MgO, g | 5 | 5 |
| DRISCAL D, g | 8 | 8 |
| 14.2 ppg CaBr₂, g | 326 | 285 |
| Sized calcium | 79 | 107 |
| carbonate 2, g | | |

| | | | | AHR |
|---|---|---|---|---|
| | Initial | AHR at 375° F. | Initial | at 375° F. |
| Rheology | 120 F. | 120 F. | 120 F. | 120 F. |
| 600 rpm | 100 | 154 | 109 | 102 |
| 300 rpm | 60 | 94 | 68 | 65 |
| 200 rpm | 46 | 76 | 52 | 50 |
| 100 rpm | 28 | 52 | 33 | 34 |
| 6 rpm | 5 | 15 | 6 | 9 |
| 3 rpm | 5 | 13 | 5 | 9 |
| PV, cP | 40 | 60 | 41 | 37 |
| YP, lbs/100 ft² | 20 | 34 | 27 | 28 |
| 10″ Gels | 4 | 9 | 4 | 5 |
| 10′ Gels | 6 | 11 | 7 | 8 |
| pH | 8.02 | 7.18 | 8.06 | 7.04 |

### Example 5

To explore the impact of the gelling agent on the rheological properties of drilling fluid formulations, two sample formulations were prepared by mixing DRISCAL® D and sized calcium carbonate as additives, with DUROGEL or a cross-linked polyvinylpyrrolidone (XPVP). The samples were formulated as shown in Table 6 below.

Before testing, the samples were hot rolled at 375° F. for 16 hours. The results of the rheological tests are provided below in Table 6 which shows that the addition of the cross-linked polyvinylpyrrolidone increases the PV values of the drilling fluid.

TABLE 6
Drilling fluids formulations and their rheological properties

| Formulation | Sample 11 | Sample 12 |
|---|---|---|
| 14.2 ppg CaBr₂, g | 105 | 105 |
| Freshwater, g | 60 | 60 |
| DUROGEL, g | 3.5 | |
| XPVP, g | | 1 |
| MgO, g | 5 | 5 |
| DRISCAL, g | 8 | 8 |
| 14.2 ppg CaBr₂, g | 326 | 326 |
| sized calcium | 79 | 82 |
| carbonate 2, g | | |

| | | | | AHR |
|---|---|---|---|---|
| | Initial | AHR at 375° F. | Initial | at 375° F. |
| Rheology | 120 F. | 120 F. | 120 F. | 120 F. |
| 600 rpm | 97 | 103 | 107 | 113 |
| 300 rpm | 58 | 63 | 65 | 68 |
| 200 rpm | 43 | 48 | 47 | 50 |
| 100 rpm | 25 | 31 | 28 | 30 |
| 6 rpm | 3 | 6 | 3 | 6 |
| 3 rpm | 3 | 5 | 2 | 4 |
| PV, cP | 39 | 40 | 42 | 45 |
| YP, lbs/100 ft² | 19 | 23 | 23 | 23 |
| 10″ Gels | 3 | 4 | 3 | 3 |
| 10′ Gels | 3 | 6 | 3 | 5 |
| pH | 7.99 | 7.22 | 7.95 | 7.22 |

### Example 6

A sample formulation was mixed, which includes DUROGEL, cross-linked polyvinylpyrrolidone, ASI D-5636 HT Thickener (commercially available from Ashland Specialty Ingredients) and sized calcium carbonate. ASI D-5636 HT Thickener is a brine thickener and also a fluid loss additive. The sample was formulated as shown in Table 7 below.

Before testing, the samples were hot rolled at 375° F. for 16 hours. The rheology of the sample was tested using a Fann 35 Viscometer at 375° F., as shown below in Table 7. Table 7 establishes that the addition of the additives increased the YP and PV of the drilling fluid, relative to the control samples under HPHT conditions.

TABLE 7
Drilling fluids formulations and their rheological properties

| Formulation | Sample 13 |
|---|---|
| 14.2 ppg CaBr₂, g | 105 |
| Freshwater, g | 60 |
| DUROGEL, g | 2 |
| XPVP, g | 1 |
| MgO, g | 5 |
| ASI D-5636 | 8 |
| 14.2 ppg CaBr₂, g | 327 |
| Sized calcium | 82 |
| carbonate 2, g | |

| | Initial | AHR at 375° F. |
|---|---|---|
| Rheology | 120 F. | 120 F. |
| 600 rpm | 98 | 67 |
| 300 rpm | 62 | 39 |
| 200 rpm | 47 | 29 |
| 100 rpm | 30 | 18 |
| 6 rpm | 7 | 3 |
| 3 rpm | 5 | 2 |
| PV, cP | 36 | 28 |
| YP, lbs/100 ft² | 26 | 11 |
| 10″ Gels | 5 | 2 |
| 10′ Gels | 6 | 2 |
| pH | 7.95 | 7.03 |

### Example 7

Three sample formulations were mixed using the following additives: DUROGEL, cross-linked polyvinylpyrrolidone, DRISCAL® D and sized calcium carbonate. The sample was formulated as shown in Table 8 below.

Before testing, the samples were hot rolled at 375° F. for 16 hours. The results of the rheological tests are provided below in Table 8. The data comparison with the control samples and the other formulations previously presented revealed that the drilling fluid formulations containing DUROGEL, DRISCAL®D and the cross-linked polyvinylpyrrolidone exhibited higher viscosity and higher gel strength. In addition, fluid loss control in HPHT conditions is improved. This establishes that drilling fluids containing DUROGEL, DRISCAL® D and the cross-linked polyvinylpyrrolidone show more improved viscosifying properties than the other formulations, particularly the control samples. Of particular significance is the comparatively improved viscosity at high and low shear rates. The comparative gel strength data further establishes improved gel strength of drilling fluid formulations.

TABLE 8
Drilling fluids formulations and their rheological properties

| Formulation | Sample 14 | | Sample 15 | | Sample 16 | |
|---|---|---|---|---|---|---|
| 14.2 ppg | 105 | | 105 | | 105 | |
| CaBr₂, g | | | | | | |
| Freshwater, g | 60 | | 60 | | 60 | |
| DUROGEL, g | 2 | | 5 | | 4 | |
| XPVP, g | 2 | | — | | 1 | |
| MgO, g | 5 | | 5 | | 5 | |
| DRISCAL D, g | 8 | | 7 | | 8 | |
| 14.2 ppg | 322 | | 322 | | 322 | |
| CaBr₂, g | | | | | | |
| Sized calcium | 84 | | 79 | | 79 | |
| carbonate 2, g | | | | | | |
| | | AHR at | | AHR at | | AHR at |
| | Initial | 375° F. | Initial | 375° F. | Initial | 375° F. |
| Rheology | 120 F. | 120 F. | 120 F. | 120 F. | 120 F. | 120 F. |
| 600 rpm | 120 | 202 | 101 | 125 | 144 | 158 |
| 300 rpm | 105 | 134 | 61 | 77 | 90 | 98 |
| 200 rpm | 80 | 102 | 46 | 56 | 63 | 76 |
| 100 rpm | 47 | 60 | 28 | 35 | 41 | 49 |
| 6 rpm | 7 | 10 | 5 | 8 | 7 | 13 |
| 3 rpm | 4 | 8 | 4 | 7 | 6 | 10 |
| PV, cP | 15 | 68 | 40 | 48 | 54 | 60 |
| YP, lbs/100 ft² | 90 | 66 | 21 | 29 | 36 | 38 |
| 10″ Gels | 4 | 7 | 4 | 6 | 5 | 9 |
| 10′ Gels | 6 | 7 | 8 | 7 | 6 | 9 |
| pH | 8.2 | 7.58 | 7.89 | 7.13 | 7.82 | 7.08 |

Table 9 depicts the fluid loss associated with the addition of different additives, according to the formulations disclosed herein. The fluid loss control was measured at 375° F. on a 3 micron disk. Of particular significance is the improved fluid loss control in HPHT conditions of the formulations containing DUROGEL, DRISCAL® D and the cross-linked polyvinylpyrrolidone. These results, as well as the viscosity data previously mentioned, establish the synergetic effect of the clay and the cross-linked polymer used as gelling materials. Therefore, the drilling fluid formulations containing the combination of the two gelling agents as disclosed herein, exhibit superior viscosifying properties, gel strength and fluid loss control in HPHT conditions.

TABLE 9
Fluid loss at 375° F. on a 3 micron disk

| | Fluid loss (mL) | | | | | | | |
|---|---|---|---|---|---|---|---|---|
| Time | | | | Sample | Sample | Sample | Sample | Sample |
| (min) | Sample 6 | Sample 7 | Sample 9 | 10 | 11 | 12 | 13 | 14 |
| 1 | 1.2 | 2.6 | 1.8 | 3.8 | 1 | 3.8 | 2.4 | 1.6 |
| 15 | 4 | 6.8 | 3.2 | 7.2 | 2.8 | 6.2 | 4.6 | 4.4 |
| 30 | 4.8 | 8.8 | 3.8 | 8.8 | 4.4 | 7.4 | 6.4 | 6 |
| 60 | 8.2 | 11.4 | 4 | 10.8 | 6.4 | 9.4 | 9.6 | 7.2 |
| 90 | 10 | 15.2 | 4.6 | 12.4 | 7 | 10 | 11.4 | 8.6 |
| 120 | 10.8 | 14.2 | 7.2 | 14 | 9 | 11.8 | 13.8 | 9.8 |
| 180 | 14.2 | 17 | 13.6 | 16.2 | 11.6 | 13.8 | 16.8 | 11 |
| 240 | 16.2 | 20 | 17 | 17.2 | 13.4 | 15 | 19.4 | 13.4 |
| 300 | 18.2 | 21.6 | 19.2 | 19 | 14.6 | 16.8 | 21.6 | 14.4 |
| 360 | 19.6 | 22.6 | 24.6 | 20 | 16.4 | 17.4 | 24.2 | 15.6 |
| 420 | | | | | 18 | — | | 16.6 |
| 480 | | | | | 19.2 | 18.6 | | 18 |
| 540 | | | | | 20.8 | 19.6 | | |
| 720 | | | | | 23.8 | 22.2 | | |
| 840 | | | | | 25 | 23.4 | | |
| 960 | | | | | 26.5 | 24.8 | | |

A sample formulation was mixed using the following additives: DUROGEL, cross-linked polyvinylpyrrolidone, DRISCAL® D and sized calcium carbonate. The sample was formulated as shown in Table 10 below.

TABLE 10
Reservoir Drill-In Fluid (RDF) formulation in zinc calcium bromide
system and its rheological properties

| Formulation | Sample 1 | | | | |
|---|---|---|---|---|---|
| 14.2 ppg | 218 | | | | |
| CaBr₂, g | | | | | |
| Freshwater, g | 63 | | | | |
| Defoamer, ml | 0.35 | | | | |
| XPVP, g | 4 | | | | |
| MgO, g | 5 | | | | |
| DRISCAL ® | 7 | | | | |
| D, g | | | | | |
| 19.2 ppg | 303 | | | | |
| CaBr₂/ZnBr₂, g | | | | | |
| sized calcium | 10.7 | | | | |
| carbonate 2, g | | | | | |
| sized calcium | 26.8 | | | | |
| carbonate 10, g | | | | | |
| sized calcium | 16.1 | | | | |
| carbonate 20, g | | | | | |
| | | 16-hr HR | 24-hr SA | 88-hr SA | 120-hr SA |
| | Initial | at 265° F. | at 265° F. | at 265° F. | at 265° F. |
| Rheology | 120° F. | 120° F. | 120° F. | 120° F. | 120° F. |
| 600 rpm | 113 | 107 | 137 | 132 | 113 |
| 300 rpm | 67 | 65 | 80 | 76 | 67 |
| 200 rpm | 47 | 47 | 56 | 55 | 48 |
| 100 rpm | 27 | 26 | 32 | 31 | 28 |
| 6 rpm | 5 | 4 | 5 | 5 | 7 |
| 3 rpm | 4 | 3 | 4 | 4 | 5 |
| PV, cP | 46 | 42 | 57 | 56 | 46 |
| YP, lbs/100 ft² | 21 | 23 | 23 | 20 | 21 |
| 10″ Gels | 4 | 3 | 4 | 5 | 5 |
| 10′ Gels | 6 | 4 | 7 | 7 | 8 |

Advantageously, embodiments of the present disclosure provide drilling fluids and methods of drilling with such fluids that include a polymeric fluid loss control agent and a gelling material such as a clay and a cross-linked polyvinylpyrrolidone. The drilling fluids of the present disclosure may advantageously be stable in HTHP conditions and prevent wellbore fluid loss up to temperatures of 375° F., whereas use of conventional fluid loss control additives may begin to experience degradation at lower temperatures. Additionally, use of drilling fluids containing a polymeric fluid loss control agent comprising an acrylamide and a sulfonated anionic monomer and a gelling material containing a clay and a cross-linked polyvinylpyrrolidone may prevent wellbore fluid loss into the formation by forming a filter cake on the wellbore walls upon filtration of the drilling fluid into the earthen formation. The use of two gelling materials, namely a clay and a cross-linked polyvinylpyrrolidone, has a synergistic effect on the rheological properties of the drilling fluid, depicted in superior viscosity and gel strength properties, as well as improved fluid loss control.

Although a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A drilling fluid, comprising:
an aqueous continuous phase;
a polymeric fluid loss control agent formed from at least an acrylamide monomer, and a sulfonated anionic monomer; and
a gelling material comprising at least one of clay or a cross-linked polyvinylpyrrolidone.

2. The drilling fluid of claim 1, further comprising:
at least one of magnesium oxide or calcium carbonate.

3. The drilling fluid of claim 1, wherein the molecular weight of polymeric fluid loss control agent is not higher than 500,000.

4. The drilling fluid of claim 1, wherein the sulfonated anionic monomer is 2-acrylamido-2-methylpropane sulfonic acid.

5. The drilling fluid of claim 1, wherein the aqueous continuous phase comprises a brine selected from the group of halide and formate based brines.

6. The drilling fluid of claim 5, wherein the halide is selected from the group of alkaline earth halides and transition metal halides.

7. The drilling fluid of claim 1, wherein a mixture of at least two gelling materials is used.

8. The drilling fluid of claim 1, wherein the polymeric fluid loss control agent is water soluble.

9. The drilling fluid of claim 1, wherein the fluid is easily transportable and maintains its properties during transportation.

10. The drilling fluid of claim 1, wherein the fluid is thermally stable to temperatures up to 450° F.

11. The drilling fluid of claim 10, wherein the fluid is thermally stable for at least 16 hours.

12. The drilling fluid of claim 1, wherein the polymeric fluid loss control agent is used in a range of 2-15 ppb.

13. The drilling fluid of claim 1, wherein the gelling material is the clay, and wherein the clay is used in a range of 1-10 ppb.

14. The drilling fluid of claim 1, wherein the gelling material is the cross-linked polyvinylpyrrolidone, and wherein the cross-linked polyvinylpyrrolidone is used in a range of 0.1-5 ppb.

15. A method of drilling, comprising:
pumping a drilling fluid into a wellbore through an earthen formation, the drilling fluid comprising:
an aqueous continuous phase;
a polymeric fluid loss control agent formed from at least an acrylamide monomer, and a sulfonated anionic monomer; and
a gelling material comprising at least one of clay or a cross-linked polyvinylpyrrolidone.

16. The method of claim 15, wherein the drilling fluid is pumped into the wellbore during the drilling through a reservoir section of the wellbore.

17. The method of claim 16, further comprising:
after drilling the reservoir section, emplacing an open hole gravel pack completion in the reservoir section.

18. The method of claim 16, wherein during the pumping, allowing filtration of the drilling fluid into the earthen formation to form a filter cake on the wellbore walls.

19. The method of claim 18, further comprising:
at least partially removing the filter cake.

20. The method of claim 16, further comprising:
initiating production of hydrocarbons from the reservoir.

21. The method of claim 19, wherein the removal of the filter cake comprises circulating a breaker fluid including at least one breaker selected from the group of organic acids, inorganic acids, hydrolysable esters of organic acids, hydrolysable esters of inorganic acids, oxidizers, and combinations thereof.

22. The method of claim 15, wherein the aqueous continuous phase comprises a brine selected from the group of halide and formate based brines.

23. The method of claim 22, wherein the halide is selected from a group of alkaline earth halides and transition metal halides.
